(19) United States
(12) Patent Application Publication
(10) Pub. No.: US 2005/0109241 A1
(43) Pub. Date: May 26, 2005

(54) High strength alumina cements

(76) Inventors: William P. Addiego, Big Flats, NY (US); Christopher R. Glose, Painted Post, NY (US)

Correspondence Address: CORNING INCORPORATED, SP-TI-3-1, CORNING, NY, 14831, US

(21) Appl. No.: 10/723,373

(22) Filed: Nov. 25, 2003

(51) Int. Cl. C04B 7/32; C04B 7/36; C04B 35/64

(52) U.S. Cl. 106/692; 106/693; 106/696; 264/630; 264/639; 264/177.12

(57) ABSTRACT

A method of making strong, high surface area alumina catalyst or catalyst supports from transition aluminas by forming a plasticized and homogenized batch which is heated under moisture-retaining conditions at a temperature and for a time at least sufficient to obtain hydroxylation of the transition alumina.

### BACKGROUND OF THE INVENTION

The present invention relates to alumina cements useful in the formation of catalysts or catalyst supports for catalytic reactors, and more particularly to a method for making strong transition alumina, particularly gamma-alumina cements useful in the production of extruded alumina honeycombs having improved strength.

High surface area transition aluminas, particularly gamma alumina, are used in the petrochemical industries as catalysts or catalyst supports for catalytic reactions. Such structures, typically in the form of pellet type structures (i.e., pellets, beads, rings, and the like) or monoliths (i.e., honeycombs) are formed by extrusion from batch mixtures of alumina and possibly other oxides, followed by drying and calcining, and exhibit a high surface area.

However, alumina catalysts or catalyst supports of the type described, particularly monolith-type structures, suffer from insufficient strength. Accordingly, in many cases boehmite, an alumina monohydrate (AlOOH) is extruded to yield mechanically strong bodies. However, boehmite looses more than a third of its mass during calcinations resulting high shrinkages possibly and cracking. Further, boehmite is a costly raw material.

To overcome some of the disadvantages associated with extruding boehmite, U.S. Pat. No. 6,365,259 proposes the use of boehmite and pseudo-boehmite as binders. However, cost issues and yield problems still exist. U.S. Pat. No. 6,365,259 discloses the use of acids in the extrusion batch to increase strength and surface area after drying and calcining. Co-pending patent application having Ser. No. 10/210,674 discloses a process in which an in-situ boehmite phase is developed in a green extruded honeycomb to provide improved strength. However, the extra processing step required to form in-situ boehmite may lead to structural damage during handling.

It would be desirable to obtain a strong alumina material which can be used for extrusion of monolith or other type catalysts or catalyst supports.

### SUMMARY OF THE INVENTION

There is provided a method of making a strong alumina cement useful in the manufacture of alumina catalysts or catalyst supports. For purposes of the present invention “alumina cement” means an alumina material that has undergone an incubation treatment to form a strong material that is capable of being extruded into monolith or other structures for catalytic reactors. For purposes of the present invention “incubation” means heating under moisture-retaining conditions at a temperature and for a time at least sufficient to obtain hydroxylation of the transition alumina powder.

In practice a batch of components comprising a transition alumina, water, a cellulose ether binder, and a pH-modifying (i.e., acid or base) component is first provided. The components are next mixed to form a substantially homogeneous plasticized mass, which is then heated under moisture-retaining conditions at a temperature and for a time at least sufficient to obtain hydroxylation of the transition alumina. The incubation step does not exceed heating beyond 100° C., with adequate hydration generally being achievable at temperatures in the 50-100° C. range within time intervals of 1-200 hours.

The invention is particularly suitable for the production of honeycomb shapes for catalysts or catalyst supports, although equally applicable to other structures, such as pellet-type structures, including pellets, beads and the like. Honeycomb structures provided herein exhibit high strength in combination with good surface area. In an embodiment, inventive honeycomb structures exhibit an a-axis crushing strength in excess of 800 psi, and a BET surface area in excess of 200 m²/g.

### DESCRIPTION OF THE INVENTION

In accordance with the method of the invention a moldable ceramic powder extrusion batch is first compounded. The extrusion batch comprises a transition alumina powder, water, a cellulose ether binder, and a pH-modifying component.

Suitable transition aluminas include any of the variety of γ-, η-, δ-, χ-, θ-, ρ-, and κ-aluminas, which are distinguished from each other principally by their crystal structure and related defect chemistry, and by their degree of hydration. Thus they are not entirely anhydrous, and in some cases their crystalline structures are at least partly dependent on the content and disposition of hydroxyl groups in the crystals. As an example, γ-alumina has been described by the composition Al_{2.5}8_{0.5}O_{3.5} (OH)_{0.5} wherein 8 represents an Al vacancy the spinel structure of the alumina crystal, and other transition alumina phases are dependent in a similar manner.

In general, when heated in the presence of water, the crystallographic structure of any of these transition aluminas will change with increasing hydroxyl content. Depending on hydration conditions, the progression may be through the moderately hydrated aluminum monohydrates or so-called oxyhydroxides (AlOOH), such as boehmite or diaspore, to pseudo-boehmites of somewhat higher water content, and finally to fully hydrated materials such as the aluminum hydroxides or alumina trihydrates (Al(OH)₃), these hydrated forms being characteristic of bayerite and gibbsite minerals.

Hydrolytic reactions between alumina and water form a batch material which can be extruded into monolithic or other structures of improved strength. Thus, the cycle of alumina phase changes, i.e., γ-alumina→AlOOH→γ-alumina, carries the potential of engineering a reasonably broad range of physical and chemical properties, including surface area and pore volume, into calcined alumina products.

A cellulose ether binder is also provided in the batch. In addition to conditioning the batch to develop the proper plasticity for extrusion and improving cohesion of the green honeycombs, these binders are also thought to have a significant impact on the drying behavior and cracking tendencies of the formed products. Cellulose ether binders that thermally gel tend to provide the highest green strength. However, strong gelling can lead to a loss of mechanical compliancy that can create cracking problems.

Consequently, suitable cellulose ether binders for purposes of the present invention include methylcellulose, hydroxypropyl methylcellulose, hydroxyethylcellulose, hydroxypropylcellulose, methylhydroxyethyl and methylhydroxypropyl cellulose ethers. The proportion to be added is not critical and can be determined by routine experiment based on the level of batch plasticity, cohesiveness, and drying homogeneity desired. Cellulose ether binders additions in the range of about 1-8% by weight in excess of the combined weight of the powder components of the batch are generally useful.

An important aspect of the present invention is the ability to control the pH of the batch with either an acid or a base. This pH modifying component can have a significant effect on the properties of the final alumina product, particularly the strength, surface area and pore volume. For an acid, the use of acetic acid is particularly preferred, although other short-chain organic acids such as formic acid are also suitable. Satisfactory results are also expected from monovalent mineral acids such as HNO₃ (nitric acid) and perhaps HCL (hydrochloric acid), if used in concentrations similar to those used in acetic acid-containing batches. The latter batches typically comprise at least 1% by weight of acid in the combined (wet) batch, more preferably about 1-5% by weight acid. For a base, the use of NH₄OH is particularly preferred. Other weak and strong Bronsted bases are also suitable, such as hydroxides and carbonates.

The dry batch components are thoroughly mixed, for example, in dry blending equipment such as a Littleford mixer. Thereafter, the blended dry batch can be transferred to batch blending and plasticizing apparatus such as a mix-muller for combination with the water and acid or base ingredients of the batch. In general, best combined batch quality is obtained by first adding the acid or base to the batch water, and then adding a well mixed dry blend of the alumina powder, cellulose ether binder, and other optional extrusion aids as known in the art, to the mix, with continued blending until a homogeneous plasticized mass is obtained. If desired, the plasticized batch produced by the muller or other mixer may then be pre-extruded through a spaghetti die one or several times, to complete the mixing process and remove any air inclusions from the mixture prior to final forming.

Flowing plasticization and homogenization, the so-formed mass or batch is next subjected to an incubation step by heating the batch under moisture-retaining conditions at a temperature and for a time at least sufficient to obtain hydroxylation of the transition alumina powder. In general, moisture-retaining conditions suitable for the practice of the invention are those conditions that will insure at least some water retention in the plasticized mass during this heating step. Physical means such as wraps or enclosures may be used for this purpose, or moist or humid conditions may be maintained, or moderate temperatures that retard the rate of water evaporation and drying of the plasticized mass can be used.

What is required is simply that the total loss of water from the plasticized mass does not occur over the duration of the treatment. The extent of hydration is time-temperature dependent, with shorter hydration times being suitable at higher temperatures. In general hydration temperatures at atmospheric pressure will not exceed 100° C., with adequate hydration generally being achievable at temperatures in the 50-100° C. range within time intervals of 1-200 hours.

Once the desired level of alumina hydration in the plasticized mass has been reached, forming thereof into alumina honeycombs or other structures can be carried out utilizing ordinary extrusion equipment together with any of the known ceramic honeycomb dies employed in the art. The handling characteristics of the alumina batches provided according to the invention are such that a relatively wide range of honeycomb geometries can readily be produced. Honeycombs having cell wall thicknesses in the range of 0.1-2 mm and cell densities in the range of 10-600 cells/in² of honeycomb cross-section can be formed with commercially available ceramic ram or screw extruders and ceramic honeycomb extrusion dies of appropriately selected dimensions and cell shapes.

Extruded alumina honeycomb shapes produced as above described may be dried in accordance with practices conventional for the production of ceramic honeycombs. Calcining of the dried honeycombs is carried out at relatively low temperatures, generally in the range of 400-600° C., for times of 1-6 hours. The calcining conditions depend on the degree of strengthening and residual porosity desired in the product. Higher temperatures and/or longer firing times tend to reduce honeycomb porosity, and vice versa. With the alumina batches provided as above described, strong bonding of a honeycomb support structure or catalyst can readily be achieved.

The ultimate physical properties of the calcined honeycomb will be dependent on other conditions as well, including but not being limited to the free water content of the batch, the phases of alumina present in the extrudate, the alumina sources, other batch processing conditions, the hydration rate during the wet heating step, the honeycomb drying temperature and rate, and the relative humidity and shrinkage of the alumina article.

The invention may be further understood by reference to the following examples, which are intended to be illustrative rather than limiting.

### EXAMPLES

For inventive examples 1 and 2 and comparative example 2 an amount of 100 grams of a commercial γ-alumina powder is dry-blended with 4 grams of F240M Methocel as an organic binder. For comparative example 1 an amount of 100 grams of a commercial boehmite powder is dry-blended with 4 grams of F240M Methocel as an organic binder.

Separately, 4 grams of glacial acetic acid are mixed with 60 grams of water. In a low-shear muller-mixer, the acetic acid solution is added to the dry-blend of the various examples with continuous mixing. A further quantity of 50-180 grams of water is then added to the mixer with blending and mixing being continued until the mixture is thoroughly mixed with water and develops a consistency that can be homogenized and plasticized under shear, by mechanical means including but not limited to high-shear mixers, augers, and extruders. The batch mixtures are then homogenized under high shear by extrusion through a spaghetti die attached to a ram extruder.

The homogenized and plasticized batch for inventive examples 1 and 2 is wrapped and sealed in plastic sheeting, and heated in an electric oven to 85° C. for hydration periods of 5.5 hours for inventive example 1 and 17.5 hours for inventive example 2. Comparative examples 1 and 2 do not receive the incubation treatment.

Thereafter the plastic wrappings are removed from the hydrated batch of inventive examples 1 and 2, and the batch thus provided is next charged into a ram extruder and extruded through a honeycomb extrusion die, the honeycomb extrudate thus produced having a cross-sectional honeycomb cell density of 200 cells/in² (cpsi) and a channel wall thickness of about 0.015 inches. The extrudate is then cut to green honeycomb sections of about 6-12″ length and calcined at 600° C. for 2 hours.

All samples are characterized for BET surface area, pore volume, median pore size and mesoporosity and evaluated for strength through A-axis crush tests (involving applying crushing force to the honeycombs in a direction parallel to the honeycomb channel axis) and % shrinkage. The results are reported in the Table 1 below.

TABLE 1

| | | | BET | | | |
|---|---|---|---|---|---|---|
| | | | Surface | Pore | Median | Meso- |
| | % | Strength | Area | Volume | Pore Size | porosity |
| Example | Shrinkage | (psi) | (m2/g) | (cc/g) | (Å) | <350 Å |
| Comp. 1 | 25-30 | 1765 | 313 | 0.64 | 69 | 99 |
| Comp. 2 | 16 | 686 | 247 | 0.85 | 132 | 93 |
| Inv. 1 | 17 | 1600 | 250 | 0.63 | 113 | 98 |
| Inv. 2 | 20 | 2750 | 238 | 0.47 | 88 | 98 |

Analysis of the data presented in the Table indicates that inventive samples 1 and 2 have crush strength comparable to or exceeding the strength of the extruded boehmite comparative example 1, and far greater than the γ-alumina comparative example 2 which did not undergo incubation. However, an advantage of the inventive examples is that they exhibit less shrinkage than the boehmite sample which providing better management of cracking issues while providing strength as high as or greater than the composition made of only boehmite.

The data also confirms that the pore volume and BET surface area can be controlled according to the teachings of the present invention. With higher strength from longer incubation time, the pore volume of the resulting article is decreased. This is desirable for making honeycomb structures with very thin dense walls as a catalyst support for fact reaction kinetics. As shown, longer incubation or hydration treatment increases the strength and decreases pore volume.

1. A method of making a strong alumina cement comprising:
a. providing a batch of components comprising a transition alumina, water, a cellulose ether binder, and a pH-modifying component;
b. mixing the batch components to form a form a substantially plasticized mass; and,
c. heating the plasticized mass under moisture-retaining conditions at a temperature and for a time at least sufficient to obtain hydroxylation of the transition alumina.

2. The method of claim 1 wherein the transition alumina is selected from the group consisting of γ-, η-, δ-, χ-, θ-, ρ-, and κ-aluminas.

3. The method of claim 2 wherein the transition alumina is γ(gamma)-alumina.

4. The method of claim 1 wherein the cellulose ether binder is selected from the group consisting of methylcellulose, hydroxypropyl methylcellulose, hydroxyethylcellulose, hydroxypropylcellulose, methylhydroxyethyl and methylhydroxypropyl cellulose ethers.

5. The method of claim 1 wherein the pH-modifying component is an acid.

6. The method of claim 5 wherein the acid is selected from the group consisting of acetic acid, formic acid, nitric acid and hydrochloric acid.

7. The method of claim 6 wherein the acid is acetic acid.

8. The method of claim 1 wherein the pH-modifying component is a base.

9. The method of claim 8 wherein the base is NH₄OH.

10. The method of claim 1 wherein mixing the batch components includes:
a. dry blending the transition alumina and cellulosic temporary binder;
b. combining the water and pH-modifying components to form a liquid mixture; and,
c. mixing the dry blend with the liquid mixture in a mix-muller to obtain a substantially plasticized mass.

11. The method of claim 1 wherein the heating step is carried out at a temperature in the range of 50-100° C. for a time in the range of 1-300 hours.

12. The method of claim 1 further comprising shaping the substantially plasticized mass into a green preform following the heating step.

13. The method of claim 12 wherein the step of forming the green preform is carried out by extrusion.

14. The method of claim 13 wherein the green preform is a honeycomb.

15. The method of claim 12 wherein the green preform is a pellet-type structure selected from the group consisting of pellets, beads, and the like.

16. A method for making a ceramic honeycomb comprising the steps of:
a. providing a batch of components comprising a transition alumina, water, a cellulose ether binder, and an acid;
b. mixing the batch components to form a substantially plasticized mass;
c. heat-treating the substantially plasticized mass under moisture-retaining conditions at a temperature and for a time at least sufficient to obtain hydroxylation of the transition alumina;
d. extruding the heat-treated mass into a green honeycomb preform; and,
e. drying and calcining the green honeycomb preform.

17. The method of claim 16 wherein the transition alumina is selected from the group consisting of γ-, η-, δ-, χ-, θ-, ρ-, and κ-aluminas.

18. The method of claim 17 wherein the cellulose ether binder is selected from the group consisting of methylcellulose, hydroxypropyl methylcellulose, hydroxyethylcellulose, hydroxypropylcellulose, methylhydroxyethyl and methylhydroxypropyl cellulose ethers.

19. The method of claim 19 wherein the acid is selected from the group consisting of acetic acid, formic acid, nitric acid and hydrochloric acid.

20. The method of claim 19 wherein the acid is acetic acid.

21. The method of claim 16 wherein the heating step is carried out at a temperature in the range of 50-100° C. for a time in the range of 1-200 hours.
